(19) United States
(12) Patent Application Publication
(10) Pub. No.: US 2014/0092397 A1
(43) Pub. Date: Apr. 3, 2014

(54) INFORMATION PROCESSING APPARATUS, AND COMPUTER-READABLE MEDIUM

(71) Applicant: FUJI XEROX CO., LTD., (US)

(72) Inventor: Kunitoshi YAMAMOTO, Kanagawa (JP)

(73) Assignee: FUJI XEROX CO., LTD., Tokyo (JP)

(21) Appl. No.: 13/875,904

(22) Filed: May 2, 2013

(30) Foreign Application Priority Data
Oct. 2, 2012 (JP) 2012-220124

(51) Int. Cl. G06T 3/40

(52) U.S. Cl. CPC G06T 3/40
USPC 358/1.2

(57) ABSTRACT

An information processing apparatus includes a detector, and first to fourth generation units. The detector detects an instruction to magnify a portion of a reduced image obtained by reducing an original image, using the first generation unit. Upon detection of the instruction, the second generation unit generates a first magnified image by magnifying the reduced-image portion such that the degree of the magnification becomes smaller from the center of the magnification toward a surrounding area. The third generation unit specifies a portion of the original image corresponding to a first magnified image region having a perimeter from which a distance to the center of the magnification is predetermined, and generates a second magnified image by magnifying the specified original image portion. The fourth generation unit composes and then outputs an image by superimposing the second magnified image on the first magnified image at the center of the magnification.

### CROSS-REFERENCE TO RELATED APPLICATIONS

This application is based on and claims priority under 35 USC 119 from Japanese Patent Application No. 2012-220124 filed Oct. 2, 2012.

### BACKGROUND

### Technical Field

The present invention relates to an information processing apparatus and a computer-readable medium.

### SUMMARY

According to an aspect of the present invention, there is provided an information processing apparatus including a first generation unit, a detector, a second generation unit, a third generation unit, and a fourth generation unit. The first generation unit generates a reduced image by reducing an original image. The detector detects a magnification instruction to magnify a portion of the reduced image. When the detector detects the magnification instruction, the second generation unit generates a first magnified image by magnifying the portion of the reduced image in such a manner a degree of the magnification becomes smaller from a center of the magnification toward a surrounding area. The third generation unit specifies a portion of the original image which corresponds to a region of the first magnified image, the region having a perimeter from which a distance to the center of the magnification is predetermined, and generates a second magnified image by magnifying the specified portion of the original image. The fourth generation unit composes an image from the first magnified image and the second magnified image in such a manner that the second magnified image is superimposed on the first magnified image at the center of the magnification in the first magnified image, and outputs the composited image.

### BRIEF DESCRIPTION OF THE DRAWINGS

Exemplary embodiments of the present invention will be described in detail based on the following figures, wherein:

FIG. 1 is a block diagram illustrating the configuration of an image forming apparatus according to an exemplary embodiment of the present invention;

FIG. 2 is a block diagram illustrating the configuration of a function achieved in a controller;

FIG. 3 is a flowchart of a process performed by the controller;

FIG. 4 is a flowchart of a process of a first subroutine;

FIG. 5 is a flowchart of a process of a second subroutine;

FIGS. 6A and 6B are graphs of a function f(r);

FIG. 7 is a diagram illustrating an exemplary preview image before magnification;

FIG. 8 is a diagram illustrating an exemplary magnified preview image;

FIG. 9 is a diagram for describing an operation according to an exemplary embodiment;

FIG. 10 is a diagram for describing an operation according to an exemplary embodiment; and

FIG. 11 is a diagram illustrating an exemplary preview image displayed on a display unit.

### DETAILED DESCRIPTION

### Exemplary Embodiment

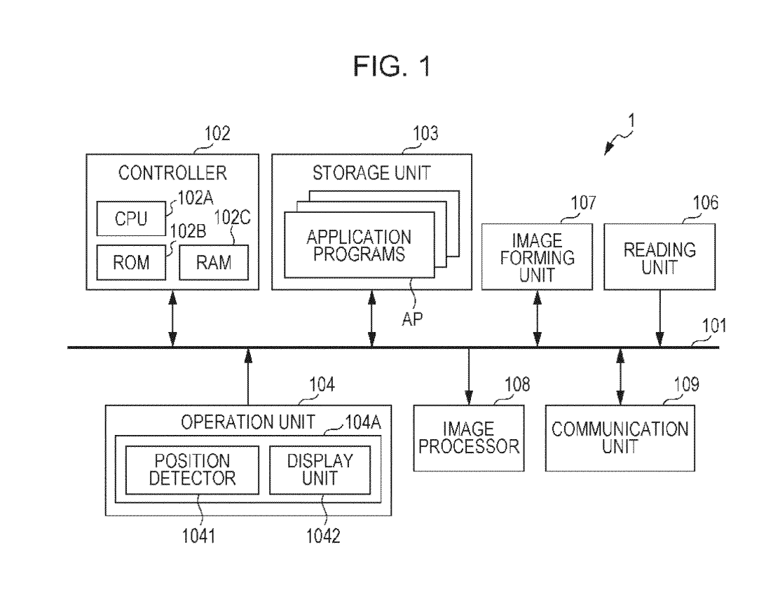

FIG. 1 is a diagram illustrating the hardware configuration of an image forming apparatus 1 according to an exemplary embodiment of the present invention. The image forming apparatus 1 according to the exemplary embodiment is an electrophotographic image forming apparatus, and is an exemplary information processing apparatus according to an example of the present invention. The image forming apparatus 1 includes an image forming function of forming an image on paper in accordance with image data transmitted from other computer apparatuses, a copy function of copying a document, and a scanning function and a facsimile function of reading out an image formed on paper and generating image data representing the image which has been read out. The image forming apparatus 1 includes a display for displaying an image, and also includes a preview function of displaying an image represented by the above-described image data on the display. The image forming apparatus 1 is not limited to that having all of the above-described functions, and may have a configuration, for example, without a facsimile function.

As illustrated in FIG. 1, the units of the image forming apparatus 1 are connected to a bus 101, and transmit data therebetween via the bus 101.

An operation unit 104 includes buttons for operating the image forming apparatus 1. The operation unit 104 includes a touch screen 104A in which a display unit 1042 which is an exemplary display unit for displaying an image is integrated with a position detector 1041 that is disposed on the surface of the display unit 1042, that is transparent so that the image displayed on the display unit 1042 is viewed through the position detector 1041, and that detects a position at which a finger which is an exemplary indicator touches the position detector 1041. As the display unit 1042, a liquid crystal display or an organic electro luminescence (EL) display is used. However, the display unit 1042 is not limited to these, and may be another type of display. As the position detector 1041, a device which detects the positions of fingers which touch the device, such as a device of electrostatic capacitance type, is used.

A communication unit 109 is connected to a communication line via a communication cable, and performs data communication with other apparatuses connected to the communication line. Examples of a communication line include a telephone line and a local area network (LAN). The communication unit 109 receives image data representing an image, for example, formed on paper from other apparatuses. The image data received by the communication unit 109 is supplied to an image processor 108. In addition, the communication unit 109 transmits image data stored through the scanning function to other apparatuses.

A reading unit 106 includes an image reading apparatus (not illustrated) which reads out characters and images formed on paper in an optical manner and which generates image data representing the read-out images. The image data generated by the reading unit 106 is stored in a storage unit 103, and is supplied to the image processor 108. The image data stored in the storage unit 103 may be supplied to the communication unit 109 so as to be transmitted to other apparatuses.

The image processor 108 subjects the supplied image data to various types of processing. The image processor 108 subjects an image represented by the supplied image data to image processing, such as color correction and tone correction, generates image data of an image for each of the colors of Y (yellow), M (magenta), C (cyan) and, K (key tone, which is black in the exemplary embodiment), from the image which has been subjected to the image processing, and outputs the generated images to an image forming unit 107.

The image forming unit 107 forms toner images on paper by using an electrophotographic system. Specifically, the image forming unit 107 includes image forming units, each of which forms a toner image for a corresponding one of the above-described colors of Y, M, C, and K. Each of the image forming units forms an electrostatic latent image on a photosensitive body in accordance with image data for a corresponding one of the colors which is supplied from the image processor 108. The image forming unit then applies toner to the surface of the photosensitive body so as to form a toner image of a corresponding color, and transfers the toner image onto paper. After the toner image transferred onto paper is fixed by applying heat and pressure thereto, the paper on which the toner image is formed is ejected out of the forming apparatus 1. In the exemplary embodiment, toner is used to form an image on paper. Alternatively, a configuration which uses ink to form an image on paper, such as an inkjet system, may be employed.

The storage unit 103 includes a storage apparatus (e.g., a hard disk apparatus) which holds data without supply of power, and stores, for example, image data received by the communication unit 109 or generated by the reading unit 106. Since image data represents an image, the storage unit 103 is an exemplary storage unit which stores images. The storage unit 103 stores, for example, programs for achieving an operating system, and application programs for achieving various functions. Application programs AP for achieving the preview function are included in the application programs.

A controller 102 includes a central processing unit (CPU) 102A, a read only memory (ROM) 102B, and a random access memory (RAM) 102C. When the CPU 102A executes an initial program loader (IPL) stored in the ROM 102B, programs for the operating system stored in the storage unit 103 are executed, causing various application programs to be ready to be executed. When the application programs are executed, for example, the image forming function, the copy function, the facsimile function, the scanning function, and the preview function which are described above are achieved.

### Functional Configuration of Image Forming Apparatus 1

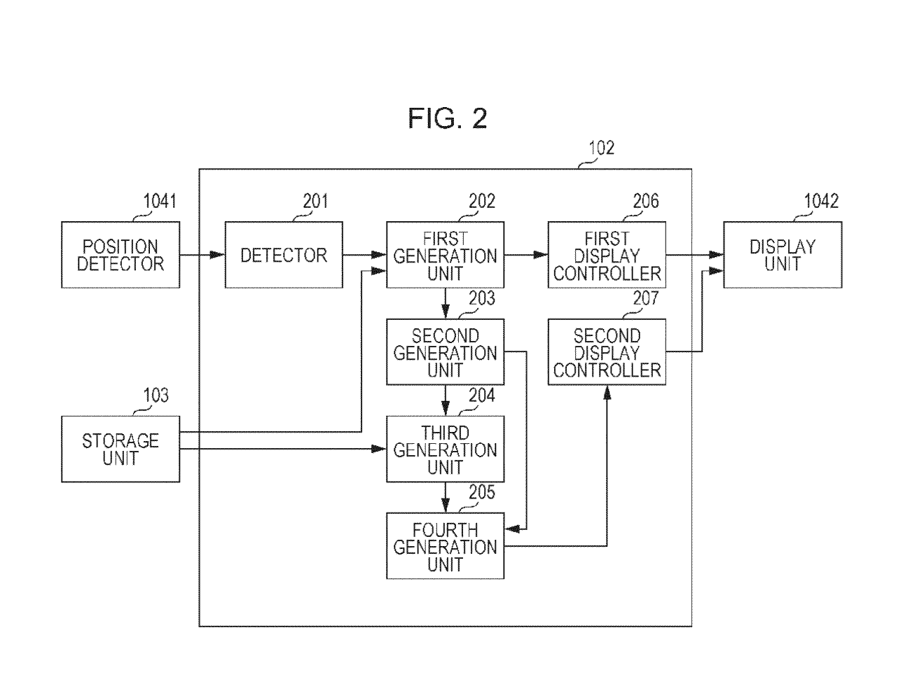

FIG. 2 is a block diagram illustrating the functional configuration related to the preview function among the functions achieved in the controller 102. Functional blocks described below are achieved by executing the application programs AP for achieving the preview function.

A detector 201 uses the positions of fingers which are detected by the position detector 1041 to detect an operation performed by a user and the positions of fingers. Examples of an operation performed by a user include an instruction operation to magnify an image displayed on the display unit 1042, and an instruction operation to reduce the magnified image back to the original image. That is, the detector 201 is an exemplary detector which detects an operation performed by a user and positions specified in the operation.

A first generation unit 202 obtains image data stored in the storage unit 103, and generates an image by reducing an image represented by the obtained image data. That is, the first generation unit 202 is an exemplary first generation unit which obtains an image having a predetermined resolution and which generates a reduced image by reducing the obtained image. In the exemplary embodiment, a method in which pixel decimation is performed is employed as the method for reducing an image. However, the method for reducing an image is not limited to pixel decimation.

A first display controller 206 controls the display unit 1042 so that a reduced image generated by the first generation unit 202 is displayed. That is, the first display controller 206 is an exemplary first display controller which controls the display unit 1042 which is an exemplary display unit so that a reduced image is displayed.

A second generation unit 203 generates a magnified image by magnifying the reduced image generated by the first generation unit 202 in such a manner that the degree of magnification becomes smaller from the position of the center of magnification toward a surrounding area. That is, the second generation unit 203 is an exemplary second generation unit which generates an image by magnifying a reduced image.

A third generation unit 204 specifies a portion corresponding to a region which is contained in the magnified image generated by the second generation unit 203 and which has a perimeter from which a distance to the position of the center of the magnification is predetermined, in the image of the image data obtained by the first generation unit 202. The third generation unit 204 then generates a magnified image by magnifying the specified image portion in the image of the obtained image data. That is, the third generation unit 204 is an exemplary third generation unit which generates an image by magnifying a specified portion in the image represented by the image data obtained from the storage unit 103.

A fourth generation unit 205 generates a composite image by superimposing the magnified image generated by the third generation unit 204 on the magnified image generated by the second generation unit 203 at the position of the center of the magnification performed by the second generation unit 203. The fourth generation unit 205 is an exemplary fourth generation unit which generates an image composed of an image obtained by magnifying a reduced image and an image obtained by magnifying an image before reduction.

A second display controller 207 controls the display unit 1042 so that the composite image generated by the fourth generation unit 205 is displayed. The second display controller 207 is an exemplary second display controller which controls the display unit 1042 so that a composite image is displayed.

In the exemplary embodiment, the functional blocks described above are achieved by executing application programs which are software. Instead of achieving the functional blocks through software, the functional blocks may be achieved through hardware such as an application specific integrated circuit (ASIC). When the functional blocks are achieved through hardware, some specific functional blocks may be achieved through hardware, and the others may be achieved through software.

### Operation of Image Forming Apparatus 1

As an exemplary operation of the image forming apparatus 1, the operation performed when the preview function is executed will be described.

When the preview function is executed in the image forming apparatus 1, the image of image data stored through the scanning function is displayed on the display unit 1042. Specifically, when an instruction operation to execute the preview function is performed using the operation unit 104, a list of image data stored in the storage unit 103 is displayed on the display unit 1042. Examples of an item displayed in the list include a file name attached to image data by the image forming apparatus 1, and the date and time at which an image was read out by the image forming apparatus 1. When a user operates using the operation unit 104 to select image data to be displayed on the display unit 1042, the controller 102 reads out the selected image data from the storage unit 103.

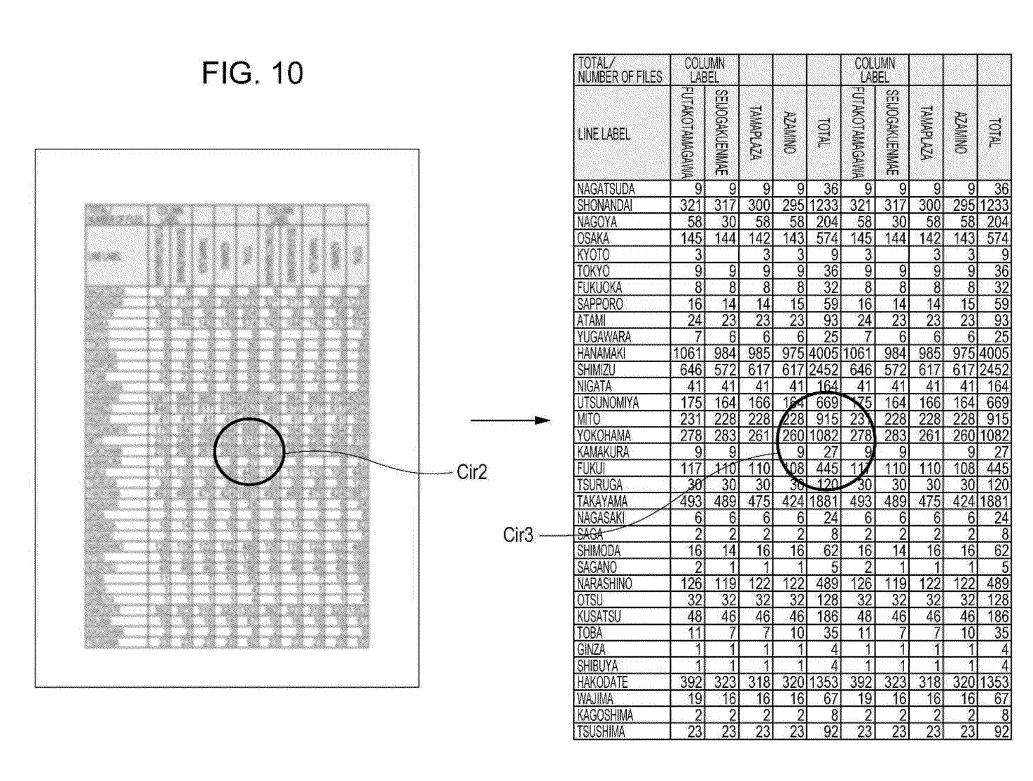

The controller 102 generates an image represented by the image data. The generated image is an image which is read out with a predetermined resolution by using the scanning function. When a table illustrated on the right side of FIG. 10 is read out using the scanning function, an image of the table is generated. Hereinafter, this image is called an original image.

Then, the controller 102 performs pixel decimation on the generated image, and generates a reduced image so as to display the entire image on the display unit 1042. When the controller 102 generates a reduced image, the controller 102 controls the display unit 1042 so that the generated image is displayed. Thus, the image of the entire table which is illustrated on the left side of FIG. 10 and which is reduced so as to contain an amount of information smaller than that of the original image is displayed on the display unit 1042. The displayed image (hereinafter, referred to as a preview image) is obtained by performing pixel decimation on the original image, and is thus a grainy image containing an amount of information smaller than that of the original image.

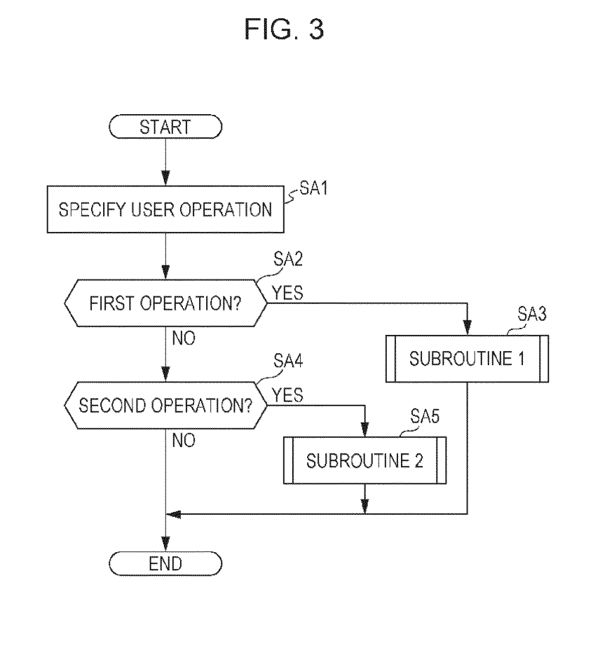

When a user touches the position detector 1041 in the state in which the image illustrated on the left side of FIG. 10 is displayed, data representing the positions at which the position detector 1041 is touched with fingers is transmitted from the operation unit 104 to the controller 102. Receiving the data representing the positions at which the position detector 1041 is touched with the fingers, the controller 102 performs the processes illustrated in FIGS. 3 to 5. First, the controller 102 uses the data transmitted from the operation unit 104 to specify the operation performed by the user on the position detector 1041 (in step SA1 in FIG. 3). Examples of a specified operation include an operation in which the position detector 1041 is touched with two fingers and in which the distance between the two touched points is made longer (hereinafter, referred to as a first operation) and an operation in which the position detector 1041 is touched with two fingers and in which the distance between the two touched points is made shorter (hereinafter, referred to as a second operation). In the state in which a preview image is displayed, the first operation indicates an instruction operation to magnify the image displayed on the display unit 1042, and the second operation indicates an instruction operation to reduce the magnified image to the original image.

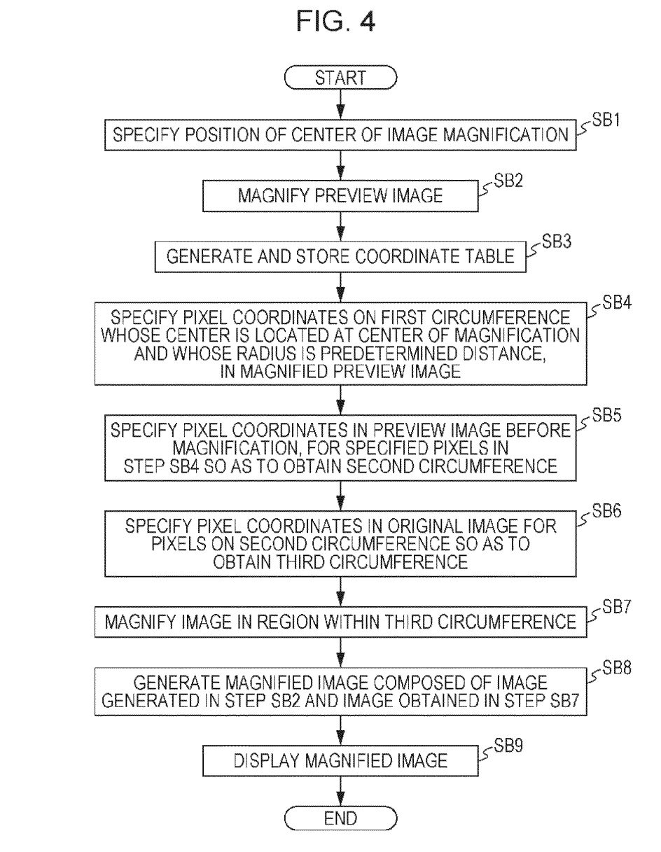

If the specified operation is a first operation, that is, an instruction operation to magnify the displayed image (YES in step SA2), the controller 102 performs the process (subroutine 1) illustrated in FIG. 4, in step SA3.

In subroutine 1, the controller 102 first specifies the position which is to be the center when the image is magnified (in step SB1). For example, when the operation is such that the position detector 1041 is touched with two fingers and the position of one finger is fixed while the other finger is moved apart from the finger whose position is fixed, the position of the center of magnification of the image is to be the position of the finger whose position is fixed. When the operation is such that the position detector 1041 is touched with two fingers and both of the fingers are moved so that the distance between the fingers is made longer, the position of the center of magnification of the image is to be the middle point of the line segment which connects the positions of the fingers.

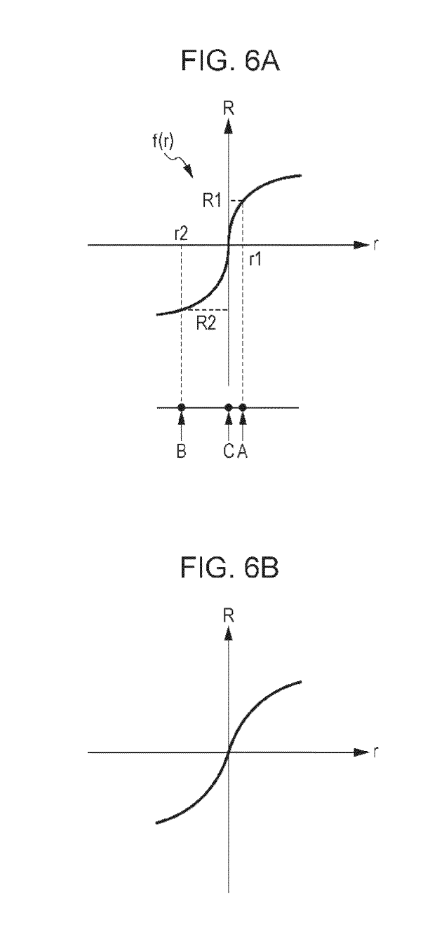

Then, the controller 102 magnifies the generated preview image by using the position specified in step SB1 as the center of the magnification (in step SB2). The controller 102 magnifies the image by changing the coordinates of pixels in the preview image by using the functions f(r) illustrated in FIGS. 6A and 6B. A function f(r) is used to determine a distance R after magnification from the position specified in step SB1 to a pixel whose distance from the specified position is r.

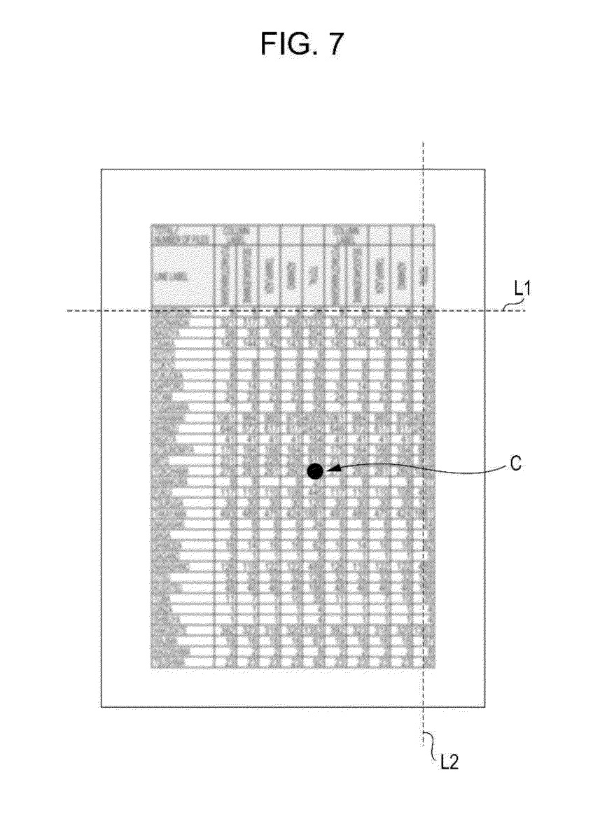

For example, in the preview image illustrated in FIG. 7, the X axis is set in the horizontal direction and the Y axis is set in the longitudinal direction. The coordinate of a pixel in the X axis direction is changed as follows. As illustrated in FIG. 6A, the position which corresponds to the center of magnification and which is specified in the image before magnification is set to a point C, and a pixel located apart from the point C by a distance r1 in the positive X-axis direction in the image before magnification is set to a pixel A. As illustrated in FIG. 6A, the distance from the point C to the pixel A in the positive X-axis direction in the image after magnification is R1. As illustrated in FIG. 6A, a pixel located apart from the point C by a distance r2 in the negative X-axis direction in the image before magnification is set to a pixel B. As illustrated in FIG. 6A, the distance from the point C to the pixel B in the negative X-axis direction in the image after magnification is R2. The controller 102 obtains the coordinate of each pixel in the X axis direction in the image after magnification from the distance R obtained from the function f(r) and the coordinate of the point C in the X axis direction.

The coordinate in the Y axis direction is changed as follows. The position which corresponds to the center of magnification and which is specified in the image before magnification is set to the point C, and a pixel located apart from the point C by a distance r1 in the positive Y-axis direction in the image before magnification is set to a pixel A. As illustrated in FIG. 6A, the distance from the point C to the pixel A in the Y axis direction in the image after magnification is R1. In addition, a pixel located apart from the point C by a distance r2 in the negative Y-axis direction in the image before magnification is set to a pixel B. As illustrated in FIG. 6A, the distance from the point C to the pixel B in the Y-axis direction in the image after magnification is R2. The controller 102 obtains the coordinate of each pixel in the Y axis direction in the image after magnification from the distance R obtained from the function f(r) and the coordinate of the point C in the Y axis direction.

The controller 102 calculates the coordinates in the X and Y axis directions for each pixel in the magnified image, and then generates a magnified preview image by disposing each pixel at the calculated coordinates.

When the coordinate of a pixel in the X axis direction is changed, the larger the distance r of a pixel from the point C in the Y axis direction in the image before magnification is, the smaller the inclination of a function f(r) which is used to change the coordinate of the pixel is. For example, when the point C is located as illustrated in FIG. 7, the distance R from the point C in the X axis direction is calculated using the function f(r) illustrated in FIG. 6A, for pixels whose coordinates in the Y axis direction are the same as that of the point C. For pixels located on the dashed line L1 in FIG. 7, that is, pixels whose distances from the point C in the Y axis direction are large, as illustrated in FIG. 6B, the distance R in the X axis direction is calculated using the function f(r) whose inclination is smaller than that in FIG. 6A.

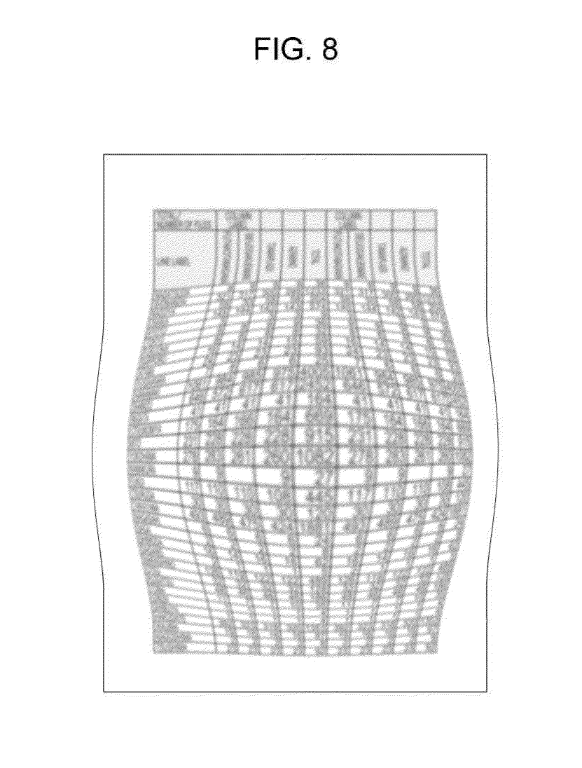

Thus, in the preview image illustrated in FIG. 8, the closer a pixel is to the point C, the larger the degree of the magnification in the X axis direction is; and the farther a pixel is to the point C in the Y axis direction, the smaller the degree of the magnification in the X axis direction is.

When the coordinate of a pixel in the Y axis direction is changed, the larger the distance r of a pixel from the point C in the X axis direction in the image before magnification is, the smaller the inclination of a function f(r) which is used to change the coordinate of the pixel is. For example, when the point C is located as illustrated in FIG. 7, the distance R from the point C in the Y axis direction is calculated using the function f(r) illustrated in FIG. 6A, for pixels whose coordinates in the X axis direction are the same as that of the point C. For pixels located on the dashed line L2 in FIG. 7, that is, pixels whose distances from the point C in the X axis direction are large, as illustrated in FIG. 6B, the distance R is calculated using the function f(r) whose inclination is smaller than that in FIG. 6A.

Thus, in the preview image illustrated in FIG. 8, the closer a pixel is to the point C, the larger the degree of the magnification in the Y axis direction is; and the farther a pixel is to the point C in the X axis direction, the smaller the degree of the magnification in the Y axis direction is.

The controller 102 generates a table in which the coordinates of each pixel before the coordinate conversion are associated with those after the coordinate conversion (hereinafter, referred to as a coordinate table), and stores the generated coordinate table in the storage unit 103 (in step SB3).

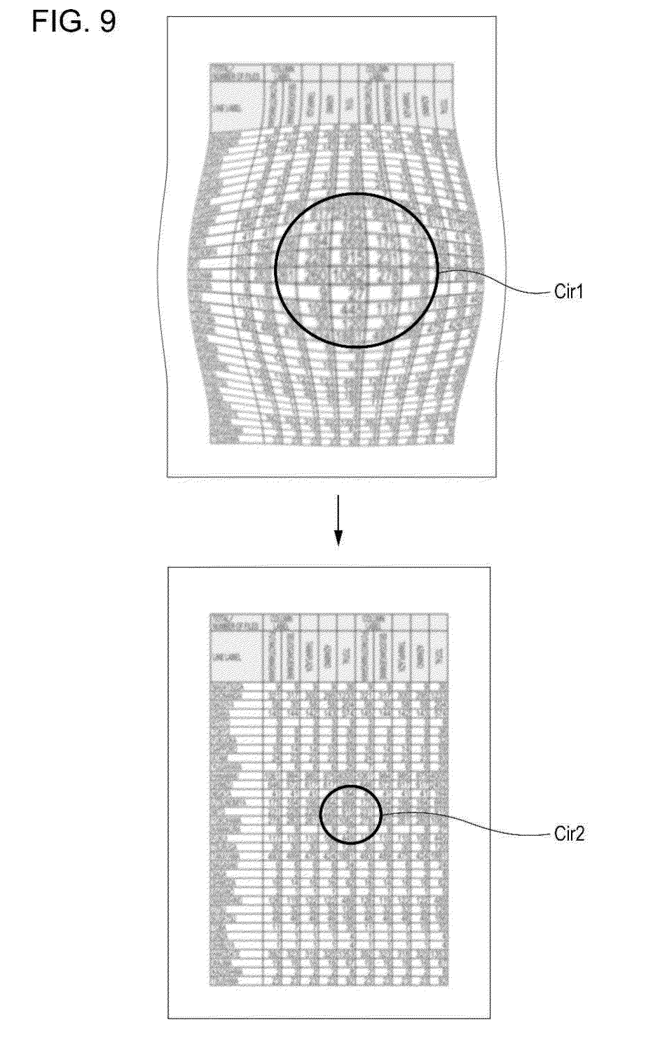

When the process in step SB3 is completed, in the preview image after magnification, the controller 102 specifies the coordinates of pixels on the circumference Cir1 of a circle (see FIG. 9) whose center is located at the center of the magnification and whose radius is a predetermined distance a (in step SB4).

For the pixels whose coordinates are specified in step SB4, the controller 102 specifies the coordinates of the pixels in the preview image before magnification (in step SB5). The coordinates of pixels before magnification and those after magnification are stored in the coordinate table. Accordingly, the coordinates of pixels before the magnification are specified by using the coordinate table.

Thus, as illustrated in FIG. 9, the coordinates of pixels on the circumference Cir2 corresponding to the circumference Cir1 are specified in the preview image before magnification.

The controller 102 specifies the coordinates of pixels on the circumference Cir2 in the original image before reduction, that is, the image represented by the image data, i.e., the image which has been read out using the scanning function (in step SB6). Thus, as illustrated in FIG. 10, the coordinates of pixels on the circumference Cir3 corresponding to the circumference Cir2 in the original image are specified.

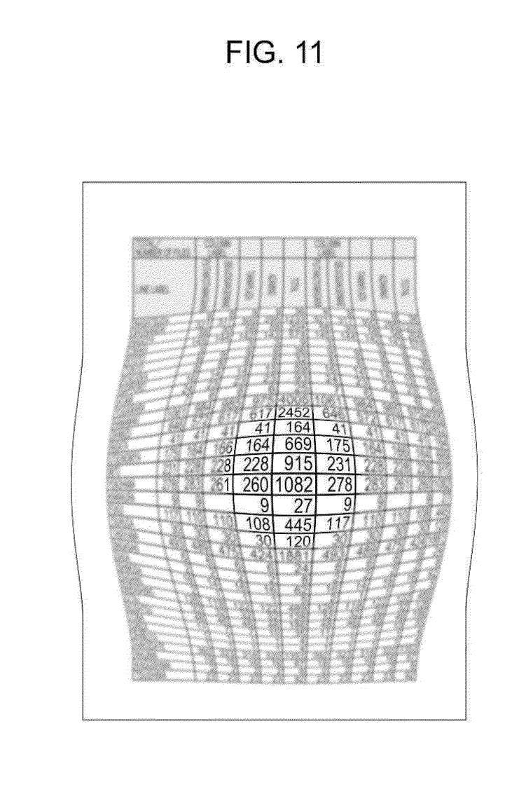

When the controller 102 specifies the pixels on the circumference Cir3, the controller 102 magnifies the image in the region within the circumference Cir3 by using the position of the center of the circumference Cir3 as the center of the magnification and using the functions f(r) (in step SB7). When the process in step SB7 is completed, the controller 102 superimposes the image obtained in step SB7 on the image generated in step SB2 (the magnified preview image illustrated in FIG. 8), and generates a composite image (see FIG. 11) composed of the image obtained in step SB7 and the image generated in step SB2 (in step SB8). An image is composed in such a manner that the position of the center of the image obtained in step SB7 matches the position used as the center of the magnification when the image generated in step SB2 is magnified.

When the composition of an image is completed, the controller 102 controls the display unit 1042 so that the image obtained through the composition is displayed (in step SB9), and ends subroutine 1.

In a displayed composite image, as illustrated in FIG. 11, an image obtained by magnifying an original image, instead of an image obtained by magnifying a preview image, is displayed in a region which has a perimeter from which a distance to the position of the center of the magnification is predetermined. That is, in the region which has a perimeter from which a distance to the position of the center of the magnification is predetermined, since an image which has not been subjected to pixel decimation and which is an image before reduction is magnified to be displayed, an image having higher definition than that of a preview image is visually recognized at the position at which magnification has been performed. In contrast, outside the region which has a perimeter from which a distance to the position of the center of the magnification is predetermined, a preview image which has been magnified, that is, an image obtained by performing pixel decimation on an original image is displayed.

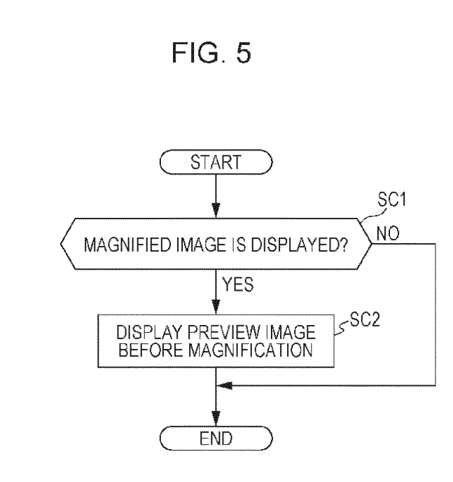

An exemplary operation performed in the case where the operation specified in step SA1 is a second operation will be described. If the operation specified in step SA1 is a second operation (YES in step SA4), the controller 102 performs a process illustrated in FIG. 5 (subroutine 2) in step SA5.

Specifically, the controller 102 first determines whether or not a preview image which is magnified in the process in step SA3 (subroutine 1) is displayed on the display unit 1042. If a magnified image is not displayed, (NO in step SC1), the controller 102 ends subroutine 2.

If the controller 102 determines that the result in step SC1 is YES, the controller 102 controls the display unit 1042 so that the preview image before the magnification (the image generated in step SB2) is displayed (in step SC2).

That is, when a second operation is performed on a magnified image being displayed, a preview image which has not been magnified is displayed instead of the magnified preview image. Thus, a user feels as if the preview image is reduced.

According to the exemplary embodiment, the preview function causes an image which has been subjected to pixel decimation to be displayed, whereby a user visually recognizes an overview of the read-out image. When an operation to magnify a preview image is performed, an image which is obtained by magnifying an original image which is an image before pixel decimation is displayed through composition in a region which has a perimeter from which a distance to the center of the magnification is predetermined, whereby an image having definition higher than that of the image which has been subjected to pixel decimation is displayed in the region which has a perimeter from which a distance to the center of the magnification is predetermined. In addition, the entire image is displayed with a portion of the image being magnified, achieving easy grasp of the position at which the magnification is performed.

### Modified Embodiments

As described above, the exemplary embodiment of the present invention is described. However, the present invention is not limited to the above-described exemplary embodiment, and other various modified embodiments may be achieved. For example, the above-described exemplary embodiment may be modified as described below, and the present invention may be embodied. In addition, the above-described exemplary embodiment and modifications described below may be combined with each other.

In the above-described exemplary embodiment, the example is described in which one portion is magnified in a preview image. However, the magnified portion is not limited to one portion, and more than one portion may be magnified to be displayed.

In the above-described exemplary embodiment, the example is described in which an image is displayed on one sheet of paper. However, when a document having more than one page is read out by using the scanning function, not only an image in one page but also images in the pages may be displayed in a tiled manner. When an operation to magnify each of the preview images displayed in a tiled manner is performed, magnification may be performed on each of the images.

In the above-described exemplary embodiment, an image displayed through the preview function is obtained from an image which has been read out through the scanning function. However, an image displayed through the preview function is not limited to an image which has been read out through the scanning function. For example, a preview image may be generated from an image of image data which is transmitted from other computer apparatuses and which is stored in the storage unit 103, so as to be displayed. Alternatively, a preview image may be generated from an image of image data transmitted through the facsimile function, so as to be displayed.

In the above-described exemplary embodiment, an apparatus provided with the preview function is the image forming apparatus 1. However, an apparatus provided with the preview function according to the above-described exemplary embodiment is not limited to the image forming apparatus 1. For example, in a computer apparatus, such as a smart phone or a tablet terminal, the above-described configuration according to the exemplary embodiment may be employed to magnify and display a preview image. In a desktop computer apparatus, the above-described configuration according to the exemplary embodiment may be employed to magnify and display a preview image.

In the above-described exemplary embodiment, pixel decimation is performed on an original image to generate a preview image. However, a method for generating a reduced image from an original image is not limited to pixel decimation, and another method, such as the average pixel method, the bilinear interpolation, or the nearest neighbor method, may be used to reduce the original image so as to generate a preview image.

In the above-described exemplary embodiment, when an instruction operation to magnify an image is performed on the touch screen 104A, a preview image is magnified. However, an instruction operation to magnify an image is not limited to that performed on the touch screen 104A.

For example, a pointer is moved by operating a mouse, and the center of magnification is specified by pressing a button of the mouse. Then, the mouse is moved with the button being pressed. Such an operation may be regarded as an instruction operation to magnify an image. In this case, the above-described magnification of an image is performed by using the position at which the button of a mouse is pressed as the position of the center of image magnification.

The application programs AP for achieving the function of magnifying a preview image according to the above-described exemplary embodiment may be provided in such a manner that a computer-readable recording medium, such as a magnetic recording medium (e.g., a magnetic tape or a magnetic disk, such as a hard disk drive (HDD) or a flexible disk (FD)), an optical recording medium (e.g., optical disk), a magneto-optical recording medium, or a semiconductor memory, stores the application programs AP, and may be installed in the image forming apparatus 1. The application programs AP may be downloaded into the image forming apparatus 1 via a communication line so as to be installed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a first generation unit that generates a reduced image by reducing an original image;
a detector that detects a magnification instruction to magnify a portion of the reduced image;
a second generation unit that generates, when the detector detects the magnification instruction, a first magnified image by magnifying the portion of the reduced image in such a manner that a degree of the magnification becomes smaller from a center of the magnification toward a surrounding area;
a third generation unit that specifies a portion of the original image, the portion corresponding to a region of the first magnified image, the region having a perimeter from which a distance to the center of the magnification is predetermined, and that generates a second magnified image by magnifying the specified portion of the original image; and
a fourth generation unit that composes an image from the first magnified image and the second magnified image in such a manner that the second magnified image is superimposed on the first magnified image at the center of the magnification in the first magnified image, and that outputs the composited image.

2. A non-transitory computer readable medium storing a program causing a computer to execute a process for processing information, the process comprising:
obtaining an original image stored in a memory and generating a reduced image by reducing the obtained original image;
controlling a display to cause the reduced image to be displayed;
detecting a magnification instruction to magnify a portion of the reduced image which is being displayed;
generating, when the magnification instruction is detected, a first magnified image by magnifying the portion of the reduced image in such a manner that a degree of the magnification becomes smaller from a center of the magnification toward a surrounding area;
specifying a portion of the obtained original image, the portion corresponding to a region of the first magnified image, the region having a perimeter from which a distance to the center of the magnification is predetermined, and generating a second magnified image by magnifying the specified portion of the obtained original image;
composing an image from the first magnified image and the second magnified image in such a manner that the second magnified image is superimposed on the first magnified image at the center of the magnification in the first magnified image; and
controlling the display to cause the composited image to be displayed.

3. An information processing apparatus comprising:
a display that displays an image;
a memory that stores an original image;
a first generation unit that obtains the original image stored in the memory and that generates a reduced image by reducing the obtained image;
a first display controller that controls the display to cause the reduced image to be displayed;
a detector that detects a magnification instruction to magnify a portion of the reduced image which is being displayed on the display;
a second generation unit that generates, when the detector detects the magnification instruction, a first magnified image by magnifying the portion of the reduced image in such a manner that a degree of the magnification becomes smaller from a center of the magnification toward a surrounding area;
a third generation unit that specifies a portion of the original image obtained by the first generation unit, the portion corresponding to a region of the first magnified image, the region having a perimeter from which a distance to the center of the magnification is predetermined, and that generates a second magnified image by magnifying an image in the specified portion of the original image obtained by the first generation unit;
a fourth generation unit that composes an image from the first magnified image and the second magnified image in such a manner that the second magnified image is superimposed on the first magnified image at the center of the magnification in the first magnified image; and
a second display controller that controls the display to cause the composited image to be displayed.
